(19) United States
(12) Patent Application Publication
(10) Pub. No.: US 2020/0128728 A1
(43) Pub. Date: Apr. 30, 2020

(54) GRASS TRIMMER AND TRIMMING HEAD

(71) Applicant: Nanjing Chervon Industry Co., Ltd., Nanjing (CN)

(72) Inventors: Jianpeng Guo, Nanjing (CN); Fangjie Nie, Nanjing (CN)

(21) Appl. No.: 16/565,636

(22) Filed: Sep. 10, 2019

(30) Foreign Application Priority Data
Oct. 26, 2018 (CN) 201811256894.5
Oct. 26, 2018 (CN) 201811256908.3
Oct. 26, 2018 (CN) 201811257249.5

(51) Int. Cl. A01D 34/416; A01D 34/84; A01D 34/90

(52) U.S. Cl. CPC A01D 34/4163; A01D 34/90; A01D 34/84

(57) ABSTRACT

A trimming head for use with a grass trimmer includes a spool for winding a cutting line and rotatable about an axis, a head housing formed with apertures for the cutting line to pass through, a touched element configured to be activated, a first driving member configured to drive the spool to rotate to send out the cutting line, and a first transmitting member configured to cooperate with a first driving member to receive a driving force of the first driving member. The trimming head has a sending mode in which a length of the cutting line extends without rotating the head housing.

### RELATED APPLICATION INFORMATION

This application claims the benefit under 35 U. S.C. § 119(a) of Chinese Patent Application No. CN 201811256908.3, filed on Oct. 26, 2018, Chinese Patent Application No. CN 201811257249.5, filed on Oct. 26, 2018, and CN 201811256894.5, filed on Oct. 26, 2018, each of which is incorporated by reference in its entirety herein.

### TECHNICAL FIELD

The present disclosure relates generally to garden tools, and specifically to a grass trimmer and a trimming head thereof.

### BACKGROUND

A grass trimmer is a garden tool and used mainly for a gardening work such as trimming the lawn. The grass trimmer is mounted with a trimming head. The trimming head is rotated at a high speed to drive a cutting line mounted on the trimming head to rotate, realizing the cutting function.

The trimming head includes a spool for winding the cutting line. When the grass trimming operation is performed, the cutting line is gradually consumed due to wear. After a period of operation, the user needs to release the cutting line on the spool. For the traditional trimming head, the user needs to dissemble the trimming head and manually release the cutting line. The operation is troublesome, the process is complicated, and the rate of string releasing is slow. In order to improve the convenience of the string releasing, some trimming heads have an automatic releasing mode or a knocking releasing mode. However, when these trimming heads having an automatic releasing mode or a knocking releasing mode suffer a heavy load or perform trimming operations in actual work, the situation that the cutting line is cut off at the eyelet member of the trimming head easily occurs, which leads to the failure of the string releasing function of the trimming head. At this moment, the case of the trimming head still needs to be disassembled to perform the string releasing, which reduces the convenience of the use of the grass trimmer.

### SUMMARY

In one example, a grass trimmer includes a trimming head configured to trim grass; and a driving device configured to drive the trimming head to rotate; wherein the trimming head comprises: a spool rotatable about an axis and formed with a winding portion for winding a cutting line; a head housing formed with apertures for the cutting line to pass through and formed with an accommodating space for accommodating at least part of the spool; a first driving member configured to drive the spool to rotate to send out the cutting line; a touched element configured to be activated by a user; and a first transmitting member configured to cooperate with the first driving member to receive a driving force of the first driving member; wherein the trimming head has a sending mode which can increase the length of the cutting line not wound to the winding portion when the head housing is not rotated; in the sending mode, the first transmitting member is driven to move towards a position to cooperate with the first driving member when the touched element is activated, and the spool is driven by the first driving member to rotate about the axis relative to the head housing to send the cutting line to the apertures during a process of the first transmitting member cooperating with the first driving member.

In another example, a trimming head, comprising: a spool rotatable about an axis and formed with a winding portion for winding a cutting line; a head housing formed with apertures for the cutting line to pass through and formed with an accommodating space for accommodating at least part of the spool; an intermediate member synchronously rotatable with the spool and slidable relative to the spool along a direction of the axis; and a touched element configured to be activated by a user and connected with the intermediate member; wherein the head housing is formed with first driving teeth to drive the spool to rotate relative the head housing, and the intermediate member is formed with first transmitting teeth for cooperating with the driving teeth; wherein the trimming head has a sending mode in which a length of the cutting line extends without rotating the head housing; in the sending mode, when the touched element is activated, the touched element drives the intermediate member to move towards a position where the first transmitting teeth cooperates with the driving teeth, the spool and the intermediate member are driven by the driving teeth to rotate relative to the head housing to send the cutting line to the apertures during the cooperating of the driving teeth and the transmitting teeth.

### BRIEF DESCRIPTION OF DRAWINGS

FIG. 1 is a perspective view illustrating a grass trimmer.

FIG. 2 is a perspective view illustrating a trimming head used by the grass trimmer in FIG. 1 mounted with a cutting line.

FIG. 3 is a cross-sectional view illustrating the trimming head in FIG. 2 without being mounted with the cutting line.

FIG. 4 is an exploded schematic view illustrating the trimming head in FIG. 2.

FIG. 5 is an exploded schematic view illustrating another angle of the trimming head in FIG. 4.

FIG. 6 is an exploded schematic view illustrating a spool of the trimming head in FIG. 2 after being mounted to a transmission member.

FIG. 7 is an exploded schematic view illustrating another angle of the spool of the trimming head in FIG. 6 after being mounted to the transmission member.

FIG. 8 is a plan view illustrating the spool of the trimming head in FIG. 5.

FIG. 9 is a cross-sectional view illustrating the spool of the trimming head in FIG. 8.

FIG. 10 is a perspective view illustrating a first housing portion of the trimming head in FIG. 7.

FIG. 11 is a perspective view illustrating a second housing portion of the trimming head in FIG .7.

FIG. 12 is a partial cross-sectional view illustrating the trimming head in FIG. 2 cross-sectioned to the transmission member.

FIG. 13 is an enlarged view of FIG. 12 at A.

FIG. 14 is a partial cross-sectional view illustrating the trimming head in FIG. 2 cut to the second driving member.

FIG. 15 is an enlarged view of FIG. 14 at B.

FIG. 16 is a plan schematic view illustrating second transmitting teeth and second driving teeth in FIG. 15 unmeshed with each other.

FIG. 17 is a plan schematic view illustrating the second transmitting teeth and the second driving teeth in FIG. 15 meshed with each other.

FIG. 18 is a transverse cross-sectional view illustrating a further trimming head.

FIG. 19 is a perspective schematic view illustrating a second housing portion of the trimming head in FIG. 18.

FIG. 20 is a perspective schematic view illustrating an eyelet member of the trimming head in FIG. 18.

FIG. 21 is a perspective view illustrating another perspective of the eyelet member of the trimming head in FIG. 20.

FIG. 22 is a combination schematic view illustrating an eyelet member assembly of the trimming head in FIG. 18.

FIG. 23 is a combination schematic view illustrating an eyelet member assembly of a still further trimming head.

FIG. 24 is an exploded schematic view illustrating the eyelet member assembly of the trimming head in FIG. 23.

FIG. 25 is a perspective schematic view illustrating a still further trimming head.

FIG. 26 is a perspective schematic view illustrating another perspective of the trimming head in FIG. 25.

FIG. 27 is a perspective schematic view illustrating an eyelet member of the trimming head in FIG. 25.

FIG. 28 is a perspective schematic view illustrating another perspective of the eyelet member of the trimming head in FIG. 27.

FIG. 29 is an exploded schematic view illustrating the eyelet member of the trimming head in FIG. 27.

FIG. 30 is an exploded schematic view illustrating another perspective of the eyelet member of the trimming head in FIG. 29.

FIG. 31 is a perspective schematic view illustrating another implementation of the eyelet member of the trimming head in FIG. 27.

FIG. 32 is an exploded schematic view illustrating the eyelet member of the trimming head in FIG. 31.

### DETAILED DESCRIPTION

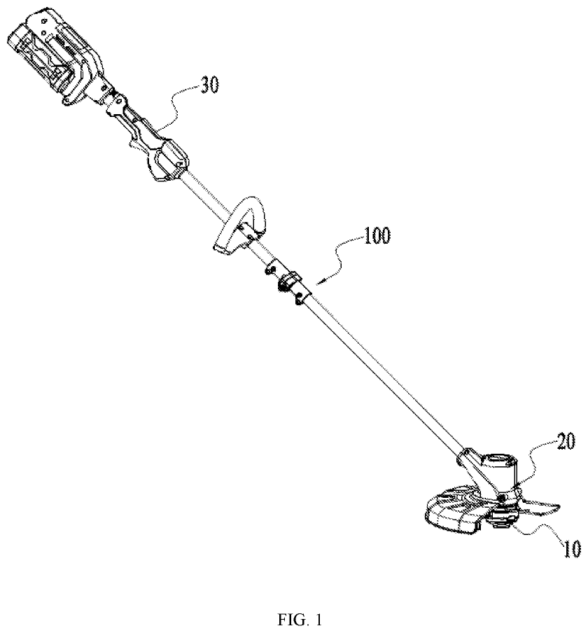

As shown in FIG. 1, a grass trimming 100 includes a trimming head 10, a driving device 20 and an operation device 30.

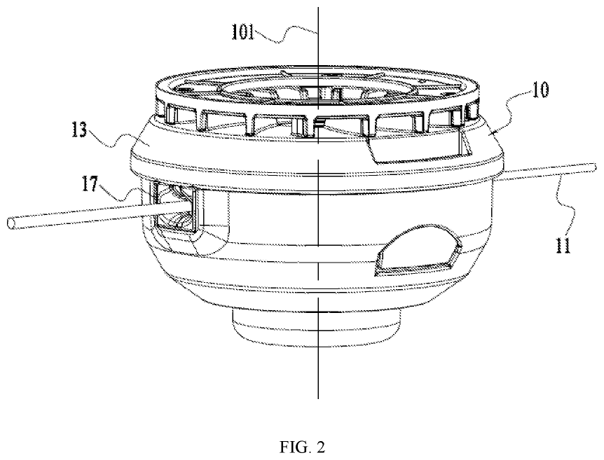

As shown in FIG. 1 and FIG. 2, the driving device 20 is configured to drive the trimming head 10 to rotate about an axis 101, so that the trimming head 10 drives the cutting line 11 to rotate to cut the vegetation. The operation device 30 is used for user operation to control the grass trimmer 100.

The driving device 20 includes a motor and a driving shaft. The driving shaft is connected to the trimming head 10 to drive the trimming head 10 to rotate about the axis 101.

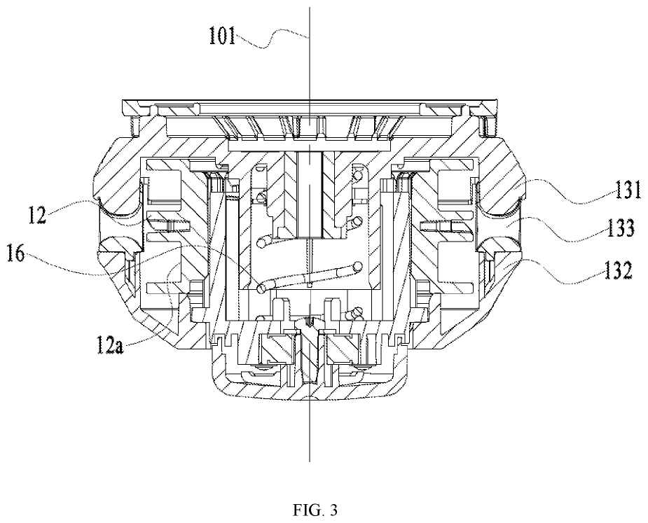

As shown in FIG. 2 and FIG. 3, the trimming head 10 includes a spool 12 and a head housing 13. The spool 12 is configured to wind the cutting line 11 and to accommodate the cutting line 11 inside the head housing 13. The spool 12 is mounted or formed with a winding portion 12a. The head housing 13 is formed with apertures 133 through which the cutting line 11 threads. An eyelet member 17 is provided at each of the apertures 133. The head housing 13 includes a first housing portion 131 and the second housing portion 132, which facilitates the assembly of the head housing 13 with the spool 12 and which also facilitates the user to open the head housing 13 to detect an inside of the head housing 13.

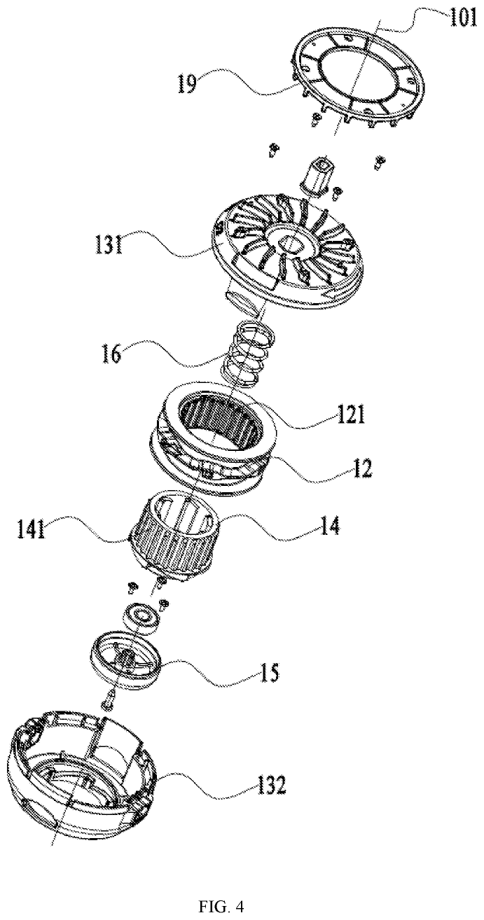

As shown in FIG. 2 and FIG. 4, the trimming head 10 further includes an intermediate member 14 arranged inside the head housing 13 and passing through the spool 12, a touched element 15 connected to the intermediate member 14, and a first elastic member 16 exerting a force between the head housing 13 and the intermediate member 14. The intermediate member 14 is an inner hollow cylinder. One end of the intermediate member 14 is closed, and another end of the intermediate member 14 is opened, so that the intermediate member 14 is formed with a chamber for accommodating the first elastic member 16. The spool 12 is sleeved on an outer surface of the intermediate member 14 and is rotatable in synchronization with the intermediate member 14.

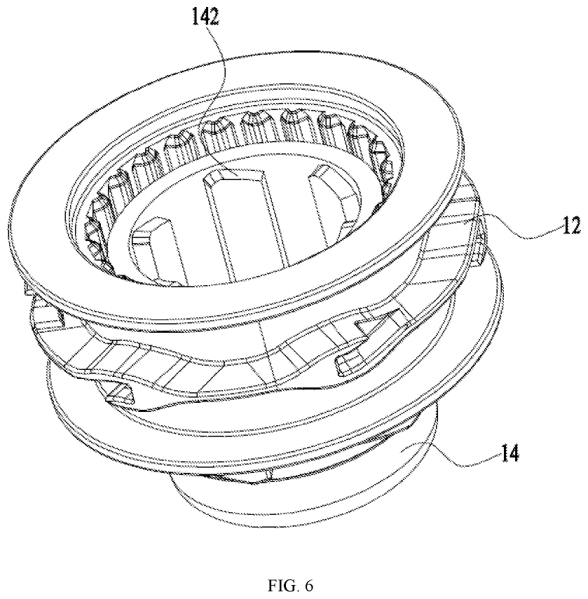

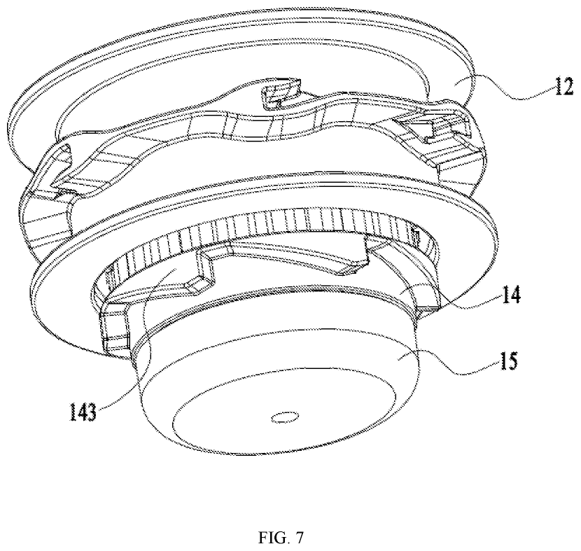

As shown in FIG. 4 to FIG. 7, the spool 12 is centered on the axis 101, and formed with a through hole about the axis 101. An inner transmitting structure 121 is formed on an inner wall of the spool 12 in the through hole. The intermediate member 14 is formed with an outer transmitting structure 141. The inner transmitting structure 121 and the outer transmitting structure 141 are fitted so that the spool 12 can be sleeved on the intermediate member 14 and rotatable in synchronization with the intermediate member 14. At the same time, the intermediate member 14 is further slideable relative to the spool 12 along a direction of the axis 101. One end of the intermediate member 14 is connected to the touched element 15 through a bearing. The touched element 15 may be a knocking cap that at least partially protrudes out of the head housing 13 to be knocked, e.g., banged against the ground or other surface. The second housing portion 132 is formed with a through hole 132f through which the touched element 15 passes. The touched element 15 is freely rotatable around the axis 101 at the one end of the intermediate member 14. The cutting line 11 is wound around the spool 12 and protrudes out of the eyelet member 17 of the head housing 13 to a preset length. The grass trimmer 100 has a cutting mode and a releasing mode. When the grass trimmer 100 is in the cutting mode, the driving device 20 is started to operate, and the driving shaft drives the trimming head 10 to rotate at a high speed. At this moment, the spool 12 and the head housing 13 is synchronously rotated, so that the cutting line 11 is driven to cut the vegetation. When the cutting line 11 is worn and shortened, the touched element 15 can be activated by the user. At this moment, the grass trimmer 100 is in the releasing mode, the driving device 20 is continued to rotate, the spool 12 is disengaged from the head housing 13 and located between the first housing portion 131 and the second housing portion 132. And then the cutting line 11 stored inside the spool 12 is released under the action of centrifugal force, and the user can continue to trim grass.

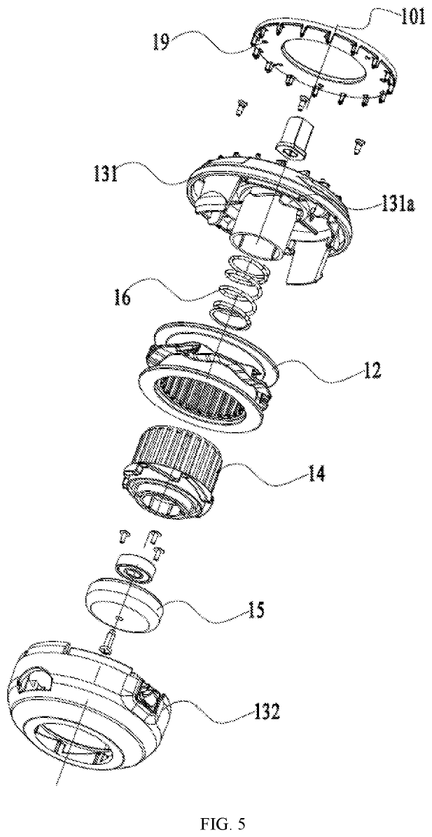

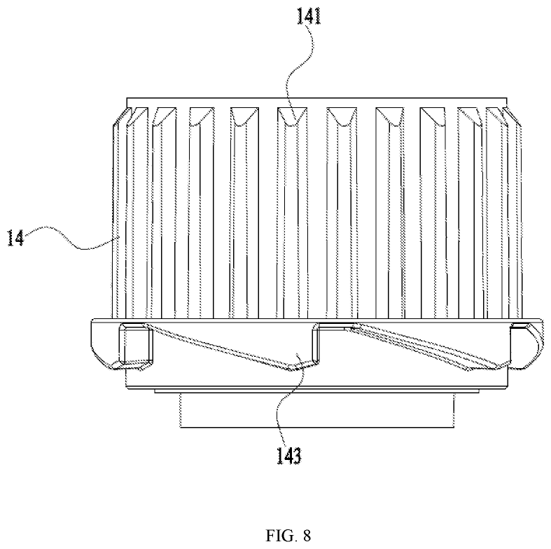

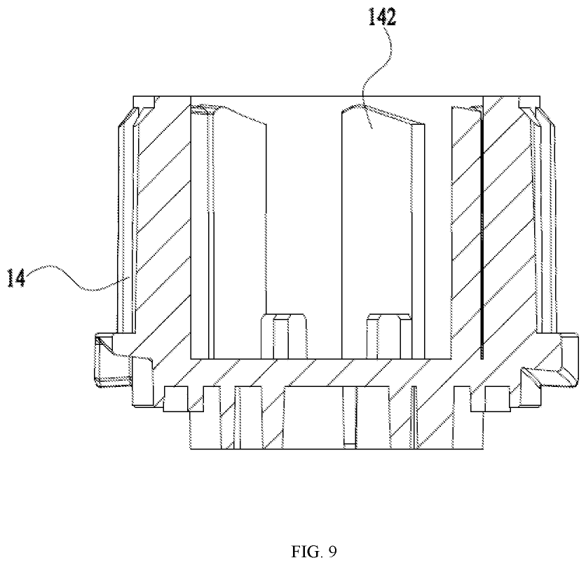

As shown in FIG. 5 to FIG. 9, the intermediate member 14 includes a first end portion and a second end portion. An inner side of the first end portion of the intermediate member 14 is formed with a first transmitting member 142. The first transmitting member 142 is integrally formed with the intermediate member 14, or the first transmitting member 142 is considered to be a part of the intermediate member 14. The first transmitting member 142 is first transmitting teeth 142a evenly distributed around an inner circumference of the intermediate member 14. A plurality of first transmitting teeth 142a are provided. The plurality of first transmitting teeth 142a are evenly distributed in a circumferential direction around the spool 101. An outer side of the second end portion of the intermediate member 14 is formed with a second transmitting member 143. The second transmitting member 143 is integrally formed with the intermediate member, or the second transmitting member 143 is considered to be a part of the intermediate member 14. The second transmitting member 143 is second transmitting teeth 143a evenly distributed about an outer circumference of the intermediate member 14. A plurality of second transmitting teeth 143a are provided. The plurality of second transmitting teeth 143a are evenly distributed in a circumferential direction about the spool 101. A number of the first transmitting teeth 142a is six, and a number of the second transmitting teeth 143a is six. The first housing portion 131 is further formed with a first driving member 131a cooperated with the first transmitting member 142.

The second housing portion 132 is further formed with a second driving member 132a cooperated with the second transmitting member 143. When the touched element 15 is activated against a knocked surface, the intermediate member 14 will approaches the first housing portion 131 along a direction parallel to the axis 101 against the elastic force of the first elastic member 16. When the intermediate 14 approaches the first housing portion 131 along the direction parallel to the axis 101, the first transmitting member 142 is cooperated with the first driving member 131a, the first driving member 131a is abutted against the first transmitting member 142 and drives the intermediate member 14 to rotate along a first rotating direction; at this moment, the first elastic member 16 is in an energy storage state. When the touched element 15 is disengaged from the surface, the first elastic member 16 releases the elastic force, the intermediate member 14 is away from the first housing portion 131; the second transmitting member 143 is cooperated with the second driving member 132a, the second driving member 132a is abutted against the second transmitting member 143 and drives the intermediate member 14 to rotate along the first rotating direction. When the intermediate member 14 is rotated along the first rotating direction, the cutting line 11 can protrude out of the eyelet member 17 and gradually extend out along with the rotation of the spool 12 due to the rigidity of the cutting line 11.

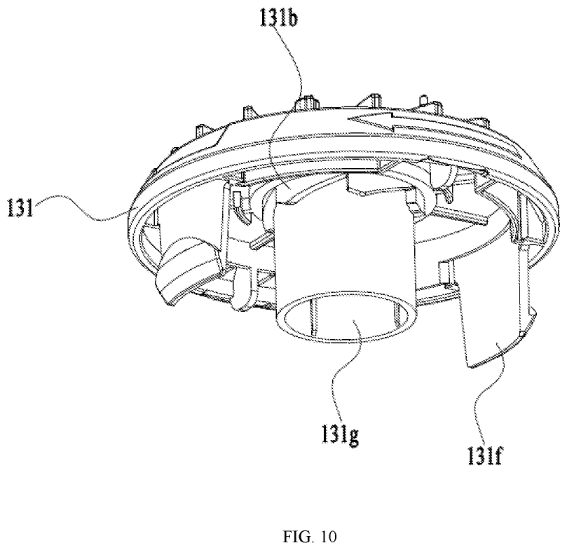

As shown in FIG. 4 to FIG. 7, and FIG. 10, the first housing portion 131 is formed with a first surface and a second surface. The first surface is connected or formed with a blade 18. The blade 18 is formed or connected with an anti-wind cap 19 capable of effective reducing the grass clippings winding to the trimming head. The second surface is formed with a mounting portion 131g about the axis 101 for mounting the spool 12. First driving teeth 131b are formed around the mounting portion 131g. The second surface is formed with a first connecting portion 131f for connecting to the second housing portion 132. It can be understood that the first driving teeth 131b may be a specific implementation of the first driving member 131a.

The mounting portion 131g is cylindrical. In order to make the mounting portion 131g have elastic force when the intermediate member 14 is mounted to the mounting portion 131g, the mounting portion 131g may also be a plurality of elastic clips formed about the axis 101. The plurality of elastic clips forms a discontinuous cylindrical surface about the axis 101. The elastic clips can be offset or away from the axis 101 to generate a radial elastic force to facilitate the mounting and dismounting of the intermediate member 14. It can be understood that the radial offset from the axis 101 may be intersected with or perpendicular to the axis 101 and not limited to a plane in which the axis 101 is located.

The first driving teeth 131b are provided to cooperate with the first transmitting teeth, and a number of the first driving teeth 131b is six. The first driving teeth 131b are formed to fitly cling to an outer side of mounting portion 131g.

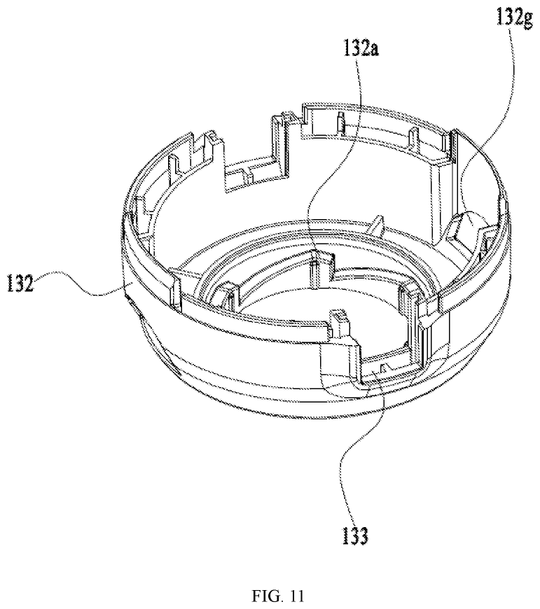

As shown in FIG. 4 to FIG. 7, and FIG. 11, the second housing portion 132 is formed as a truncated cone shape around the axis 101, and includes a bottom surface and a side wall. The bottom surface of the second housing portion 132 is further formed with the through hole 132f through which the touched element 15 passes. The side wall of the second housing portion 132 is formed with two connecting holes 132g into which the first connecting portion 131f of the first housing portion 131 is inserted to connect the first housing portion 131 with the second housing portion 132. The side wall of the second housing portion 132 is formed with the apertures 133 for the cutting line 11 threading out, and each of the apertures 133 is located between the two connecting holes 132g. The eyelet member 17 is mounted at the apertures 133. Since the cutting line 11 suffers a greater friction force at the eyelet member 17 and the eyelet member 17 is worn more seriously, the eyelet member 17 may be a metal member. The second driving member 132a is further formed at the through hole 132f of the second housing portion 132. The second driving member 132a is second driving teeth 132b evenly distributed on an inner wall of the through hole 132f of the second housing portion 132 about the axis 132. A plurality of second driving teeth 132b are provided. The second driving teeth 132b are provided to cooperate with the second transmitting teeth 143a.

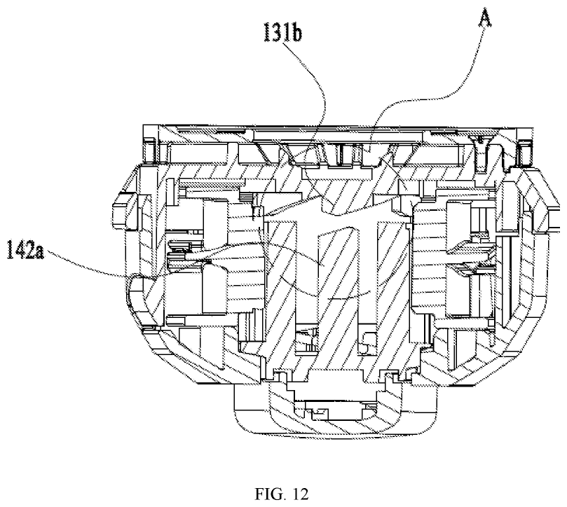

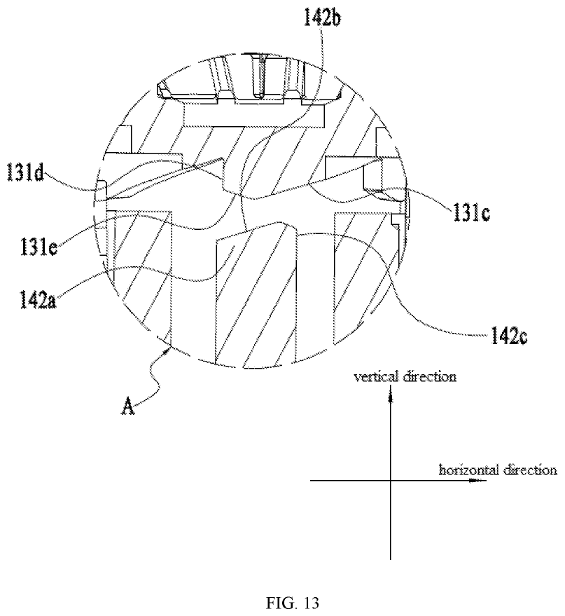

As shown in FIG. 12 and FIG. 13, in order to facilitate the description of the technical solution of the present disclosure, directions indicated by the arrows in FIG. 13 are defined as a horizontal direction and a vertical direction, respectively. A direction facing toward the vertical direction shown in the drawings is further defined as a first moving direction, and a direction facing away the vertical direction shown in the drawings is defined as a second moving direction.

Each of the first transmitting teeth 142a includes a first transmitting surface 142b and a first stop surface 142c. The first transmitting surface 142b extends in a first plane obliquely intersected with the axis 101. The first stop surface 142c extends in a second plane substantially parallel to the axis 101. A smooth chamfer is formed at a connection of the first transmitting surface 142b and the first stop surface 142c. Each of the first driving teeth 132b includes a second transmitting surface 131c, a second stop surface 131d and a first continuous surface 131e. The second transmitting surface 131c extends in a third plane obliquely intersected with the axis 101. The first continuous surface 131e extends in a fourth plane obliquely intersected with the axis 101. The second surface 131d extends to a preset length along the first moving direction. A smooth chamfer is formed at a connection of the first continuous surface and the second transmitting surface 131c.

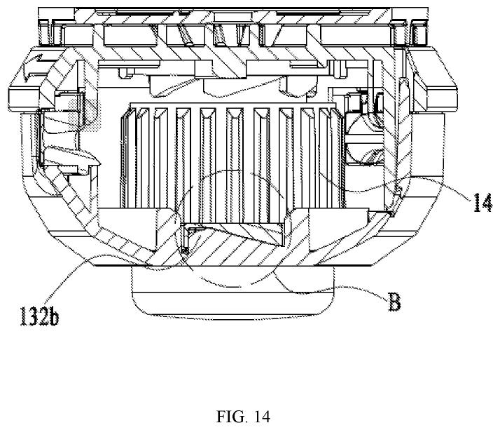

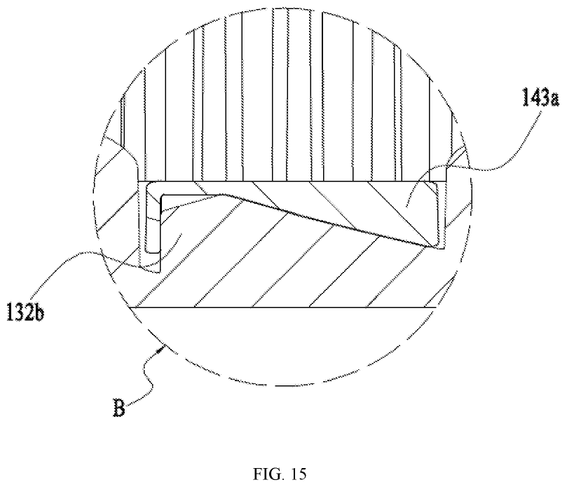

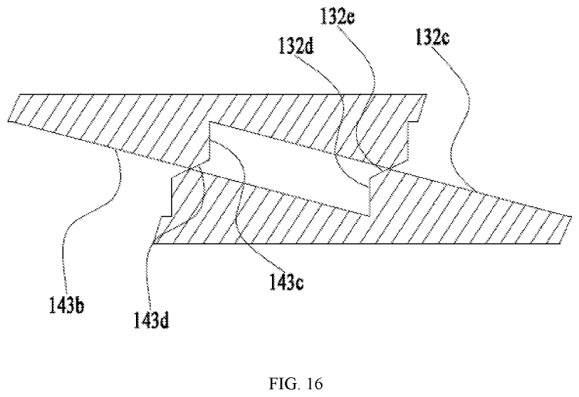

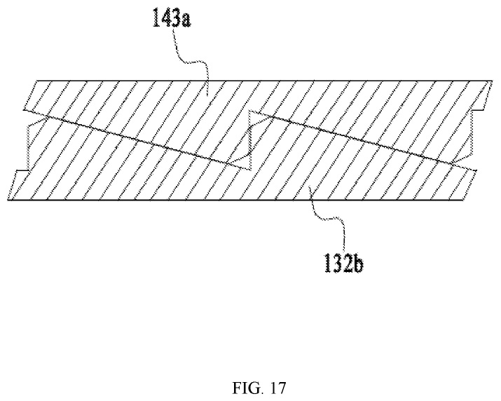

As shown in FIG. 14 to FIG. 17, each of the second transmitting teeth 143a of the intermediate member 14 includes a third transmitting surface 143b and a third stop surface 143c. The third transmitting surface 143b extends in a fifth plane obliquely intersected with the axis 101. The third stop surface 143c extends to a preset length in a plane substantially parallel to the axis 101. Each of the second driving teeth 132b includes a fourth transmitting surface 132c, a fourth stop surface 132d and a third continuous surface 132e. The fourth transmitting surface 132c extends in a plane obliquely intersected with the axis 101. The fourth stop surface 132d extends to a preset length along the second moving direction. A smooth chamfer is formed at a connection of the third continuous surface 132e and the fourth transmitting surface 132c.

When the user operates the grass trimmer 100 to trim the grass, since the cutting line 11 is normally worn during the grass trimming process, a certain length of the cutting line 11 needs to be released to continue the grass trimming after the cutting line 11 is used for a period of time. During the using process of the trimming head 10, the first housing portion 131, the first elastic member 16, the intermediate member 14, the spool 12, the cutting line 11, the touched element 15, and the second housing portion 132 constitute a whole synchronously rotating around the axis 101. When the cutting line 11 needs to be released by the user, the touched element 15 is activated against the surface, the intermediate member 14 overcomes the elastic force of the first elastic member 16 to move along the first moving direction, and the second transmitting teeth 143a of the intermediate member 14 are disengaged from the second driving teeth 132b of the second housing portion 132. Before the first transmitting teeth 142a of the intermediate member 14 are in contact with the first driving teeth 131b of the first housing portion 131, the intermediate member 14 and the spool 12 are disengaged from the head housing 13 and not synchronously rotated along with the head housing 13, and the cutting line 11 is released under the action of the inertial force. When the touched element 15 is disengaged from the knocking surface, the intermediate member 14 moves along the second moving direction under the action of the elastic force of the first elastic member 16. When the first transmitting teeth 142a are disengaged from the first driving teeth 131b, the intermediate member 14 and the spool 12 are disengaged from the head housing 13 again and not synchronously rotated along with the head housing 13. The cutting line 11 is continued to be released under the action of the inertial force, so that a cycle of string releasing is completed.

It can be understood that the first driving teeth 131b and the first transmitting teeth 142a are staggered, and the second driving teeth 132b and the second transmitting teeth 143a are staggered, so that a cycle of string releasing is realized. Otherwise, when the first transmitting teeth 142a approach the first driving teeth 131b, the first transmitting teeth 142 would be directly meshed with the first driving teeth 131b and the transmission would not exist; and when the second transmitting teeth 143a approach the second driving teeth 132b, the second transmitting teeth 143a would be directly meshed with the second driving teeth 132b and the transmission would not exist, thus the spool 12 would be unable to be driven to rotate.

The grass trimmer 100 further has a sending mode. When the grass trimmer 100 is in the sending mode, the length of the cutting line 11 may be extended when the head housing 13 is not driven by the motor. The first housing portion 131 or the second housing portion 132 generates a driving force to the spool 12, driving the spool 12 to rotate relative to the head housing 13 to send out the cutting line 11.

During the grass trimming process, when the cutting line 11 is cut off at the apertures 133, a head end portion of the cutting line 11 is not exposed outside of the head housing 13, and the user's hand cannot extend into the apertures 133 to pull out the cutting line 11. Even if the grass trimmer 100 is in the releasing mode, the centrifugal force of the cutting line 11 is small and the head end portion is restricted by a wall of the apertures 133 so that the cutting line 11 cannot be sent out. The operation device 30 is controlled, so that an inputting device of the trimming head 10 stops operating. Then the touched element 15 is activated, the intermediate member 14 overcomes the elastic force of the first elastic member 16 to move along the first moving direction, and the first transmitting teeth 142a of the intermediate member 14 are in contact with the first driving teeth 131b of the first housing portion 131, and the first transmitting surface 142b is in contact with the second transmitting surface 131c. When the touched element 15 is activated, the touched element 15 drives the intermediate member 14 to move along the first moving direction and exerts a force on the head housing 13, and the force is transferred to the first driving teeth 131b through the first transmitting teeth 142a. At this moment, the first driving teeth 131b give the first transmitting teeth 142a a reactive force, and the reactive force has a component force in a direction obliquely intersected with the axis 101, which drives the first transmitting teeth 142a to move on the first intermediate member 142 along the first rotating direction to the first stop surface 142c of the next first driving teeth 131b, so that the intermediate member 14 is rotated by a preset angle along the first rotating direction under the driving of the first driving teeth 131b. At this moment, the spool 12 is synchronously rotated by the preset angle along the first rotating direction under the driving of the intermediate member 14. The cutting line 11, due to a certain rigidity of the cutting line 11, can automatically protrude a certain length out of the eyelet member 17 when the spool 12 is rotated.

When the touched element 15 is disengaged from the knocked surface, the intermediate member 14 moves along the second moving direction under the action of the elastic force of the first elastic member 16. At this moment, the first transmitting teeth 142a are disengaged from the first driving teeth 131b, and the second transmitting teeth 143 are in contact with the second driving teeth 132b. The intermediate member 14 has a force on the head housing 13 due to the action of the first elastic member 16, and the force is transferred to the second driving teeth 132b through the second transmitting teeth 143a. At this moment, the second driving teeth 132b give the second transmitting teeth 143a a reactive force, and the reactive force has a component force in a direction obliquely intersected with the axis 101, which drives the second transmitting teeth 143a to move on the second driving teeth 132b along a direction obliquely intersected with the axis 101 to the second stop surface 131d of the next driving teeth 132b, so that the intermediate member 14 is continued to rotate by a preset angle along the first rotating direction driven by the second driving teeth 132b. At this moment, the spool 12 is synchronously rotated by the preset angle along the first rotating direction under the driving of the intermediate member 14. The cutting line 11, due to a certain rigidity of the cutting line 11, can automatically protrude a certain length out of the eyelet member 17 when the spool 12 is rotated, so that a cycle of motion of the intermediate member 14 is completed. Since the first driving teeth 131b and the second driving teeth 132b have a corresponding relationship, the spool 12 is rotated by about 60 degrees in one cycle. If the cutting line 11 is not sent out to the preset length, the above action can be repeated, so that the cutting line 11 continues to be sent out until the preset length is reached. Thus, when the cutting line 11 is cut off at the eyelet member 17 and cannot be released through the centrifugal force, the cutting line 11 is capable of extending or protruding out of the grass trimming buckle 17 by repeatedly activating the touched element 15. Since the first transmitting teeth 142a, first driving teeth 131b, the transmitting teeth 143a, and the driving teeth 132b are each provided with six teeth, and a gap between adjacent two first transmitting teeth 142a is relatively small, the spool 12 is rotated by about an angle of 60 degrees every time the touched element 15 is activated. In fact, such angle is only a theoretical value, the angle by which the spool 12 is rotated may be slight less than or slight greater than 60 degrees in actual operation. Or in some other examples, the numbers of the first transmitting teeth, the first driving teeth, the second transmitting teeth and the second driving teeth are arranged to be other values, then the angle by which the spool is rotated is dependent upon the other values every time the touched element is activated. Or, the gap between the adjacent two first transmitting teeth may be relatively large, namely, the adjacent two first transmitting teeth about the axis is discontinuous, the angle by which the spool is rotated may accordingly have other values every time the touched element is activated.

It can be understood that the first transmitting member 142, the second transmitting member 143, the first driving member 131a and the second driving member 132a are not limited to the above arrangement. The intermediate member 14 may also not be utilized and only a transmitting structure for driving the spool 12 to rotate may be formed on the spool 12. The transmitting structure may be a driving portion formed on or connected to the head housing 13, or a driving portion formed on or connected to the spool 12 and abutted against the first driving teeth 131b or the second driving teeth 132b. In short, along the direction of the axis 101, other devices which can convert the axial displacement generated by the first housing portion 131 or the second housing portion 132 into the circumferential rotation so as to send out the cutting line 11 are all within the protection scope of the present disclosure.

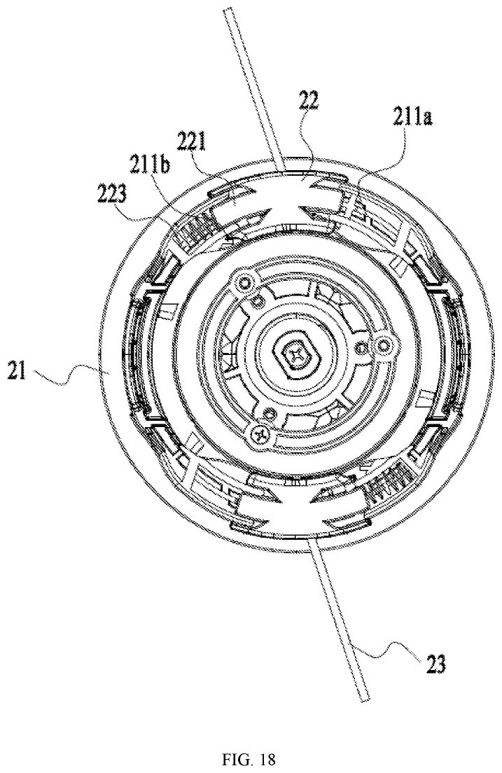

Another trimming head shown in FIG. 18 includes another eyelet member assembly 22 different from the eyelet member 17. In the present example, the eyelet member assembly 22 is movably mounted to the head housing 21. The head housing 21 is formed with a movable portion used for the eyelet member 221 to move along the circumferential direction of the head housing 21. In one example, the movable portion is a first accommodating groove 211. The eyelet member 221 forms apertures for the cutting line 23 threading in or out. When the cutting line 23 acts on the apertures, the eyelet member 221 may be displaced relative to the head housing 21. The eyelet member assembly 22 may optimize the stress distribution at outer apertures 212, preventing the cutting line 23 from being cut off at the outer apertures 212 due to excessive local stress at the outer apertures 212 when the trimming head suffers a heavy load or performs the trimming operation.

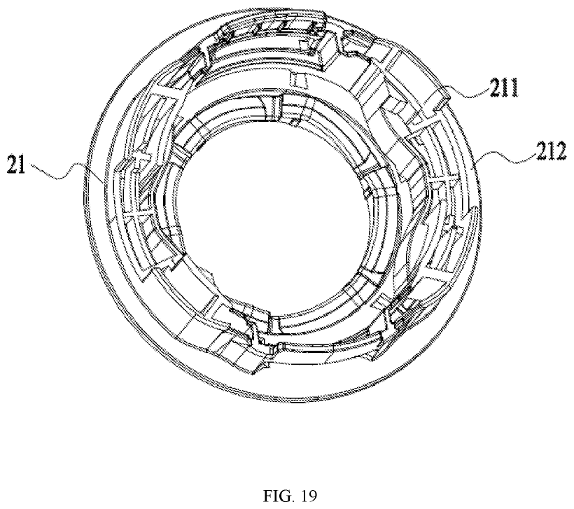

As shown in FIG. 18 and FIG. 19, the eyelet member 221 is movably mounted to the first accommodating groove 211. The first accommodating groove 211 is formed with a guiding rail 221 in the circumferential direction and used for the eyelet member 221 to slide, and is further formed with a stop portion 211b for preventing the eyelet member 221 from sliding out of the outer apertures 212. It can be understood that the eyelet member 221 is mounted to the first accommodating groove 211 along the first axial direction during the assembly. The eyelet member 221 may freely slide only in the circumferential direction under the force generated when the cutting line 23 is rotated at a high speed. Due to the action of the stop portion 211b, the eyelet member 221 does not slide out of the outer apertures 212 when sliding along the circumferential direction of the head housing 21.

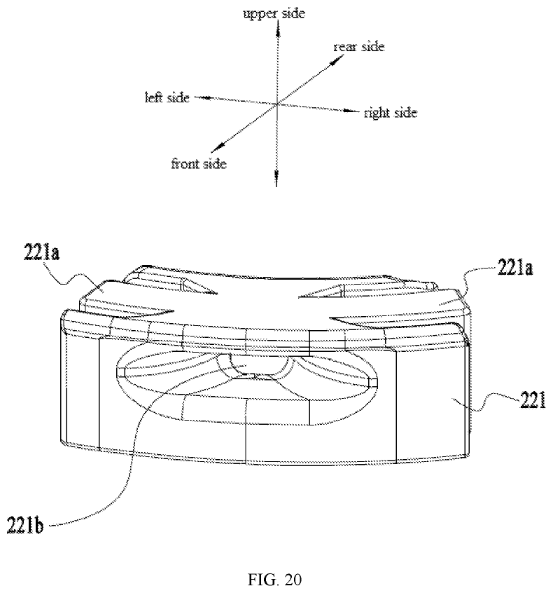

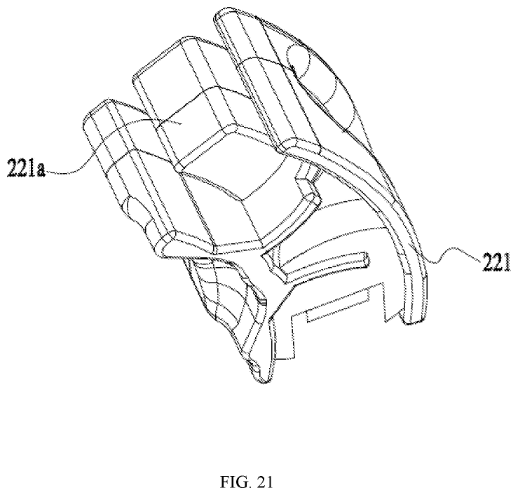

As shown in FIG. 20 and FIG. 21, in order to facilitate the description of the technical solution of the present disclosure, directions indicated by the arrows in FIG. 20 are defined as an upper side, a lower side, a left side, a right side, a front side and a rear side.

In a left-right direction, the eyelet member 221 is formed with a second connecting portion 221a. One or two second connecting portions 221a may be provided. In the present example, two second connecting portions 221a are provided. In one example, the second connecting portion 221a may be embedded in the guiding rail 211a of the head housing 21. It can be understood that, in other examples, the second connecting portion 221a may further adopt other movable connecting mechanisms which can generate relative motions.

In a front-rear direction, the eyelet member 221 is further formed with first apertures 221b penetrating through the eyelet member 221. The first apertures 221b is gradually enlarged from the rear side to the front side, and a curve surface inside the first apertures 221b is continuous and smooth, which can reduce the friction between the cutting line 23 and a hole wall, and can reduce the probability that the cutting line 23 is cut off at the eyelet member 221. It can be understood that, when the trimming head performs the grass trimming along the first rotating direction, the cutting line 23 has a tendency to rotate along the second rotating direction due to the reactive force of the grass. And the cutting line 23 basically acts on the right side of the string outlet in the actual operation, thus cutting line 23 has a relatively large force relative to the right side of the eyelet member 221. Therefore, when the cutting line 23 acts on the apertures, the eyelet member 221 may be displaced relative to the head housing 21.

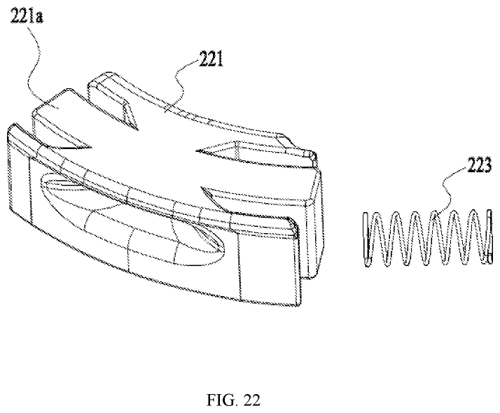

As shown in FIG. 18 and FIG. 22, in the present example, the eyelet member assembly 22 further includes a buffering member 223 connected to one end of the eyelet member 221. When the cutting line 23 acts on the eyelet member 221, the eyelet member 221 may bias the buffering member 223 and move relative to the circumferential direction of the head housing 21. At this moment, at least part of the force of the cutting line 23 on the eyelet member 221 is transferred to the buffering member 223, thereby reducing the force between the cutting line 23 and the eyelet member 221.

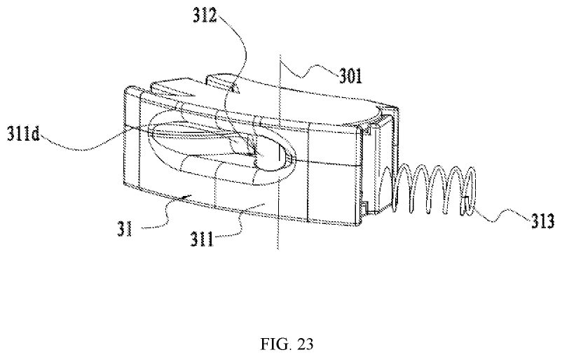

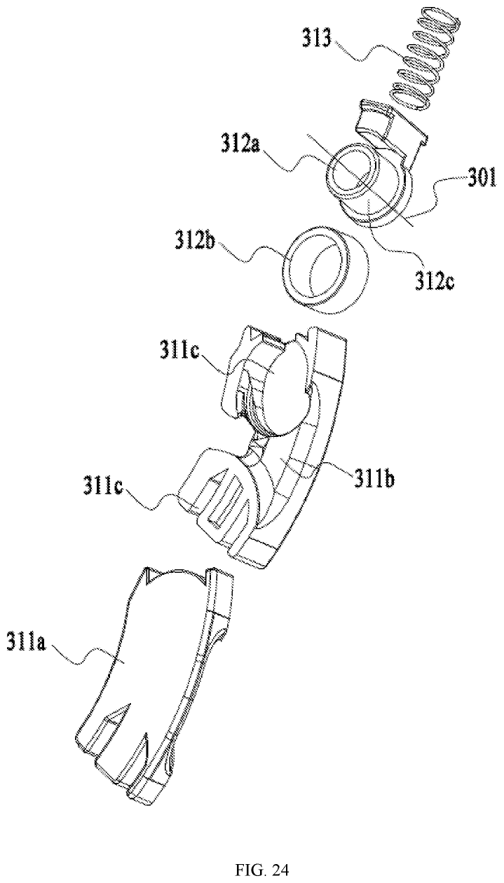

FIG. 23 and FIG. 24 show an eyelet member assembly 31 of the third example. In the present example, the eyelet member assembly 31 includes an eyelet member 311 and a wear reducing member 312. The eyelet member 311 includes a first main body portion 311a and a second main body portion 311b. The first main body portion 311a and the second main body portion 311b are fixedly connected as a whole through bonding or other connection manners, and are formed with an installing portion 311c for installing the wear reducing member 312. It can be understood that the first main body portion 311a and the second main body portion 311b are arranged to facilitate the installation of the wear reducing member 312. The wear reducing member 312 can also be connected to the eyelet member 311 by other manners, for example, the wear reducing member 312 is directly placed into the mold during the molding process of the eyelet member 311, so that the eyelet member 311 and the wear reducing member 312 are integrally injection-molded; or, the eyelet member 311 is formed with a through hole for installing the wear reducing member 312. Any manner that can realize the wear reducing member 312 being fixedly connected to the eyelet member 311 and directly acting on the cutting line can be adopted.

It can be understood that, in the actual operation, the cutting line basically acts on the right side of the string outlet, thus the cutting line has a relatively large force on the right side of the eyelet member 311. Such force may accelerate the wear of the cutting line at the right side of the eyelet member 311, thereby reducing the strength of the cutting line at the eyelet member 311, thereby further causing the cut off of the cutting line at the eyelet member 311 due to excessive local stress when the cutting line suffers a relatively heavy load or performs trimming operation. Therefore, the wear reducing member 312 is arranged at the right side. In the present example, the wear reduction member 312 includes a base 312a and a first rotating member 312b.

As shown in FIG. 24, the first rotating member 312b is mounted to the base 312a and rotatable relative to the base 312a about a first central direction 301, thereby converting sliding friction or static force of the cutting line relative to the hole wall on the right side of the string outlet into rolling friction, thereby effectively reducing the frictional force between the cutting line and the first apertures 311d. In one example, the first rotating member 312b is placed on the base 312a formed with or mounted with a first rotating shaft 312c. At least part of the installing portion 311c is communicated with first apertures 311d. When the base 312a is installed to the installing portion 311c, the base 312a is freely movable within the range of the installing portion 311c along the left-right direction shown in the drawings. During the assembly, the base 312a is in contact with the buffering member 313, and an eccentric pressure is provided. Namely, in the left-right direction, the buffering member 313 bias the base 312a directly or indirectly, so that the base 312 is abutted against the left side of the installing portion 311c. In one example, the first rotating member 312b may be a bearing, the bearing is sleeved on the first rotating shaft 312c, so that the first rotating member 312b is freely rotatable about the first rotating shaft 312c. In addition, the first rotating member 312b is sleeved on the first rotating shaft 312c and further movable along an axial direction of the first rotating shaft 312c, so that the cutting line is capable of driving the first rotating member 312b to move up and down when the force of the cutting line acting on the first rotating member 312b is relatively large and the up and down shaking occurs. Therefore, the rolling friction between the cutting line and the first rotating member 312b can be maintained, and the cutting line is prevented from shaking up and down relative to the first rotating member 312b to produce a secondary sliding friction or static friction to wear the cutting line. It can be understood that, the first rotating member 312b is capable of synchronously moving along with the base 312a under the action of the buffering member 313, when the first rotating member 312b is mounted to the base 312a.

The buffering member 313 is arranged at the right side of the eyelet member 311 and placed inside the first accommodating groove of the head housing. It can be understood that, the buffering member 313 may be fixedly, or detachably connected to the wear reducing member 312, or only be located inside the first accommodating groove and in contact with the wear reducing member 312. In the present example, the buffering member 313 is a spring. It can be understood that, in other examples, the buffering member 313 may be other elastic members, such as magnetic members with same poles oppositely arranged, an airbag, or a sponge. During the assembly, the wear reducing member 312 is fitly clung to the buffering member 313 and a certain pre-pressure is generated, so that the buffering member 313 can absorb sufficient cushioning force when the wear reducing member 312 acts on the buffering member 313.

Through the above structural arrangement, when the user performs grass trimming operation and the cutting line threads into or out of the eyelet member 311, especially in the string releasing or string winding process, the cutting line is capable of driving the first rotating member 312b to rotate since the wear reducing member 312 is arranged between the cutting line and the eyelet member 311. Thus, the interaction force between the cutting line and the eyelet member 311 is changed from the sliding friction or static friction into the rolling friction, and the interaction force between the cutting line and the eyelet member 311 is reduced. When the trimming head suffers a relatively large load or performs the trimming operation, the local stress of the cutting line at the first apertures 311d is excessive, and then the cutting line transfers such stress to the buffering member 313 through the wear reducing member 312, thereby reducing the acting force between the cutting line and the eyelet member 311, and reducing the probability that the cutting line is cut off at the eyelet member 311.

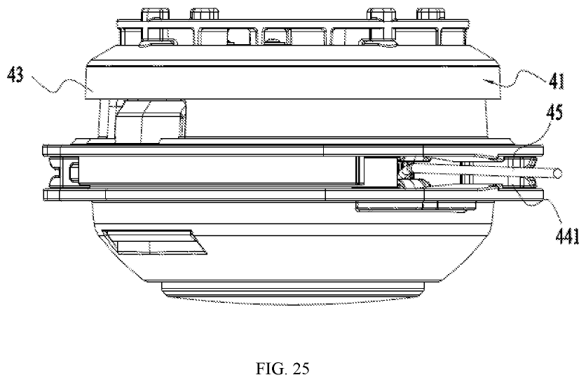

In order to prevent the cutting line 45 from being cut off directly at the eyelet member such that the cutting line 45 is stuck inside the eyelet member and cannot be automatically or manually released, an eyelet member structure of the fourth example shown in FIG. 25 is arranged. In the present example, the trimming head 41 includes a string guiding buckle 443 that specifies the string cut off, and an eyelet member body for the cutting line 45 threading in or out. The acting force of the cutting line 45 relative to the eyelet member body when the cutting line 45 pass through the eyelet member main body is less than the acting force of the cutting line 45 relative to the string guiding buckle 443 when the cutting line 45 pass through the string guiding buckle 443.

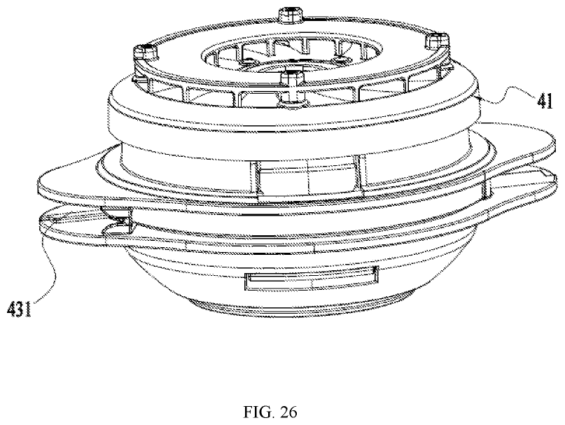

As shown in FIG. 25 and FIG. 26, the head housing is formed with a third accommodating groove 431 for accommodating the string guiding buckle 443. In one example, the third accommodating groove 431 is composed of two second protruding portions formed on the head housing 43 at a position of eyelet member. Since at least part of the eyelet member is protruded from the body of the trimming head 41, the trimming head 41 is rotated at a high speed and inevitably comes into contact with the outside during the operation of the grass trimmer to trim the grass. In such process, the string guiding buckle 443 is easily damaged, therefore, the third accommodating groove 431 is arranged to protect the string guiding buckle 443 and prevent the string guiding buckle 443 from being damaged by external force.

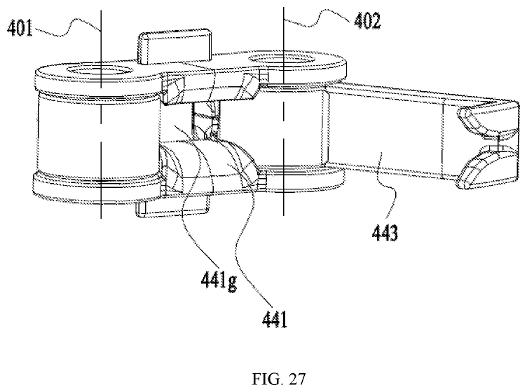

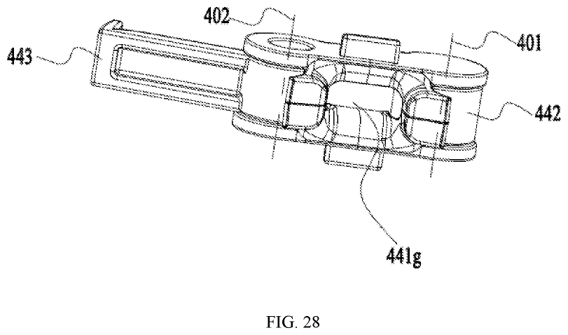

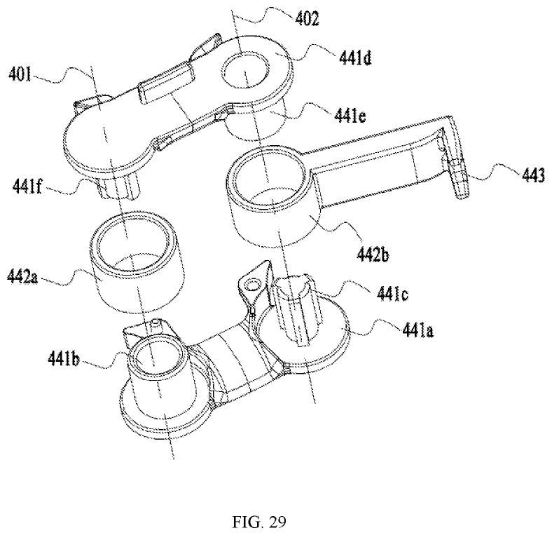

As shown in FIG. 27 to FIG. 29, in the present example, the second eyelet member assembly 44 includes an eyelet member body 441, a second wear reducing member 442, a string guiding buckle 443. The eyelet member body 441 includes a first body portion 441a and a second body portion 441d. The first body portion 441a and the second body portion 441d are fixedly or detachably connected to each other to form the eyelet member body 441. The eyelet member body 441 is formed with second apertures 441g for the cutting line 45 threading in and out. An inner wall of the second apertures 441g is continuous and smooth. The first body portion 441a is formed or connected with a second rotating shaft 441b and a first anti-fall portion 441c. The second body portion 441d is formed or connected with a third rotating shaft 441e and a second anti-fall portion 441f. In one example, the second rotating shaft 441b or the third rotating shaft 441e is a hollow first cylinder, one end of the second rotating shaft 441b or the third rotating shaft 441e is opened, and other end is formed with or connected to the eyelet member main body 441.

In one example, the first anti-fall portion 441c or the second anti-fall portion 441f is a second cylinder an outer diameter of which is less than an inner diameter of the second rotating shaft 441b or the third rotating shaft 441e. An outer surface of the second cylinder is further formed or connected with third protruding portions. The third protruding portions are evenly distributed around the second cylinder and have a certain elastic force.

In the present example, a plurality of third protruding portions are provided. It can be understood that, one or more third protruding portions may be provided, or a continuous protruding structure around the second cylinder may be provided, as long as the first anti-fall portion 441c cannot be actively disengaged from the second rotating shaft 441b when the first anti-fall portion 441c is stuck in the second rotating shaft 441b, or the second anti-fall portion 441f cannot be actively disengaged from the third rotating shaft 441e when the second anti-fall portion 441f is stuck in the third rotating shaft 441e. The second wear reducing member 442 includes a second rotating member 442a and the third rotating member 442b. At least part of the second rotating member 442a and the third rotating member 442b is communicated with the second apertures 441g.

In one example, the second rotating member 442a may be a rotating bearing or a roller that is mounted to the second rotating shaft 441b, and rotatable about a second central direction 401 in which the second rotating shaft 441b is located. In addition, the second rotating member 442a is axially movable along the second central direction 401. The third rotating member 442b is connected or formed with the string guiding buckle 443. The string guiding buckle 443 includes a connecting portion 443a, an extending portion 443b and a string guiding portion 443c. The connecting portion 443a is connected to or formed on the third rotating member 442b.

In the present example, the string guiding buckle 443 is integrally formed with the third rotating member 442b. A tail end of the extending portion 443b extending from the connecting portion 443a is connected or formed with a string guiding portion 443c. The string guiding portion 443c is substantially in a “V” shape. The cutting line 45 may be stuck inside the string guiding portion 443c, and freely slidable in the string guiding portion 443c.

In one example, a surface of the string guiding portion 443c is formed with a continuous and smooth curve surface, which can effectively reduce the interaction force between the string guiding portion 443c and the cutting line 45, and reduce the wear rate of the cutting line 45 at the string guiding portion 443c. Moreover, the string guiding buckle 443 is rotatable about the third rotating direction along with the third rotating member 442b. When the cutting line 45 passes through the eyelet member, in the cutting mode, the cutting line 45 has a tendency to rotate along the second rotating direction due to the reactive force of the grass and the like. At this moment, the cutting line 45 drives the third rotating member 442b to rotate to a preset direction along the second rotating direction, and the string guiding buckle 443 supports the cutting line 45 to prevent the cutting line 45 from being wound to the trimming head 41.

It can be understood that, by the above structural arrangement, when the cutting line 45 passes through the eyelet member body 441, the cutting line 45 generates the rolling friction with the second rotating member 442a at the second string outlet, and is in line contact with the third rotating member 442b to generate a relatively small sliding friction. When the cutting line 45 passes through the string guiding buckle 443, the cutting line 45 is in surface contact with the surface of the string guiding portion 443c to generate a friction slightly greater than the friction of the cutting line 45 passing through the second apertures 441g of the eyelet member. Therefore, the probability that the cutting line 45 is cut off at the string guiding buckle 443 is much greater than the probability that the cutting line 45 is cut off at the eyelet member body 441. When the cutting line 45 is cut off at the string guiding buckle 443, there is a certain length between a cut-off end of the cutting line 45 and the eyelet member, so that the cutting line 45 may be re-released without disassembling the trimming head 41.

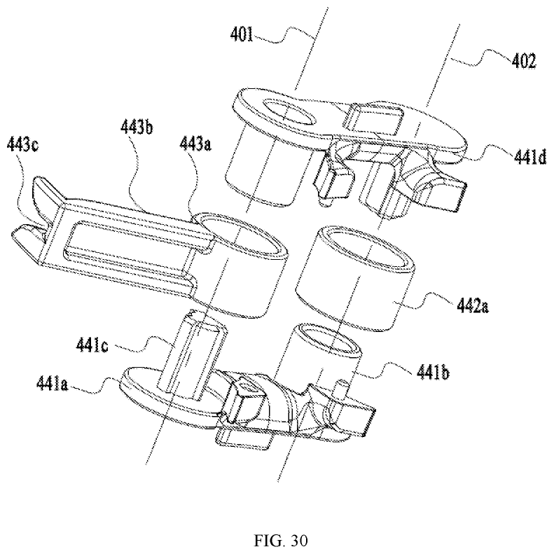

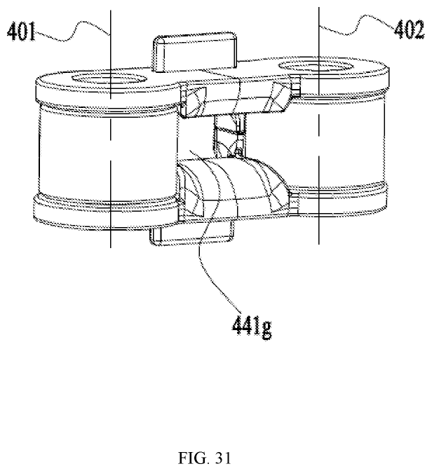

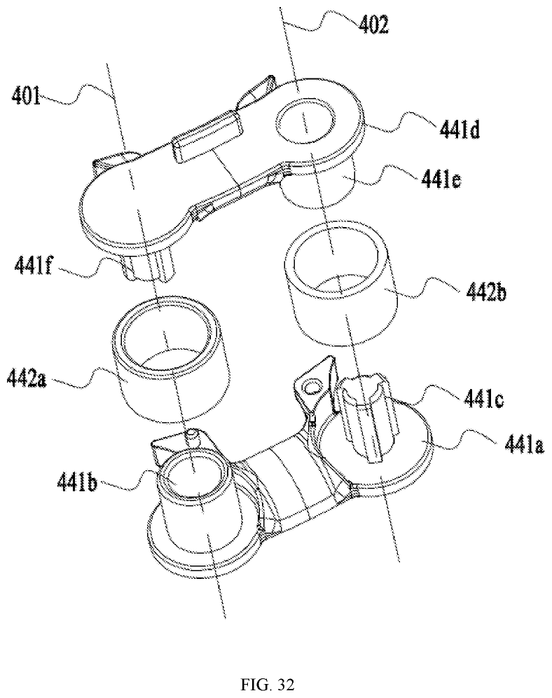

As shown in FIG. 30 to FIG. 32, the third rotating member 442b may not be provided with the string guiding buckle 443. At this moment, the third rotating member 442b is freely rotatable about the third central direction 402, and axially movable along the third central direction 402. The rolling friction is generated when the cutting line 45 is in contact with the second rotating member 442a or the third rotating member 442b at the second apertures 441g, which greatly reduces the interaction force between the cutting line 45 and a contact surface of the second string thread hole 441g. Thus the situation of string outgoing failure due to the cutting line 45 being cut off at the eyelet member body 441, and the cut-off end being stuck inside the eyelet member body 441 and unable to protrude out, or the cut-off end being retraced into the eyelet member body 441, are reduced.

The basic principles, main features and advantages of the present disclosure have been shown and described above. It is to be understood by any person skilled in the art that the foregoing examples are not intended to limit the present disclosure in any form. All technical solutions obtained by equivalent substitution or equivalent transformation are within the scope of the claims that follow.

What is claimed is:

1. A grass trimmer, comprising:
a trimming head configured to trim grass; and
a driving device configured to drive the trimming head to rotate;
wherein the trimming head comprises:
a spool rotatable about an axis and formed with a winding portion for winding a cutting line;
a head housing formed with apertures for the cutting line to pass through and formed with an accommodating space for accommodating at least part of the spool;
a first driving member configured to drive the spool to rotate to send out the cutting line;
a touched element configured to be activated by a user; and
a first transmitting member configured to cooperate with the first driving member to receive a driving force of the first driving member;
wherein the trimming head has a sending mode which can increase the length of the cutting line not wound to the winding portion when the head housing is not rotated and, in the sending mode, the first transmitting member is driven to move towards a position to cooperate with the first driving member when the touched element is activated and the spool is driven by the first driving member to rotate about the axis relative to the head housing to send the cutting line to the apertures during a process of the first transmitting member cooperating with the first driving member.

2. The grass trimmer according to claim 1, wherein the grass trimmer further has a cutting mode in which the cutting line is driven to trim the grass and, in the cutting mode, the spool drives the head housing and the cutting line to rotate about the axis so that the cutting line rotates at a high speed to trim the grass.

3. The grass trimmer according to claim 1, wherein the grass trimmer further has a releasing mode in which the head housing is rotated about the axis and a length of the cutting line protruding out of the head housing is releasable and, in the releasing mode, the spool is disengaged with the head housing and freely rotatable, and the cutting line is released by a centrifugal force.

4. The grass trimmer according to claim 1, wherein when the trimming head is in the sending mode, the touched element is activated to drive the first transmitting member to move along a direction parallel to the axis and the first driving member and the first transmitting member are caused to cooperate to convert an axial movement of the first transmitting member into an axial movement and a circumferential rotation of the spool.

5. The grass trimmer according to claim 4, wherein the trimming head further comprises:
a biasing element configured to bias the first transmitting member to be reset in the direction parallel to the axis;
a second driving member configured to drive the spool to send the cutting line to the apertures during the resetting of the first transmitting member in the direction parallel to the axis; and
a second transmitting member configured to cooperate with the second driving member to receive a driving force of the second driving member.

6. The grass trimmer according to claim 5, wherein the head housing comprises a first housing portion and a second housing portion, the first driving member is fixedly connected to or integrally formed with the first housing portion, and the second driving member is fixedly connected to or integrally formed with the second housing portion.

7. The grass trimmer according to claim 5, wherein the first driving member comprises first driving teeth distributed in a circumferential direction around the axis, the first transmitting member comprises first transmitting teeth distributed in the circumferential direction around the axis, the first driving teeth and the first transmitting teeth are staggered in the circumferential direction around the axis, the second driving member comprises second driving teeth distributed in the circumferential direction around the axis, the second transmitting member comprises second transmitting teeth distributed in the circumferential direction around the axis, and the second driving teeth and the second transmitting teeth are staggered in the circumferential direction around the axis.

8. The grass trimmer according to claim 7, wherein each of the first transmitting teeth comprises a first transmitting surface extending in a plane obliquely intersected with the axis and a first stop surface extending in a plane substantially parallel to the axis, each of the first driving teeth comprises a second transmitting surface extending in a plane obliquely intersected with the axis, and a driving force for driving the spool to rotate is generated when the first transmitting surface and the second transmitting surface are caused to interact with each other.

9. The grass trimmer according to claim 7, wherein each of the second transmitting teeth comprises a third transmitting surface extending in a plane obliquely intersected with the axis and a second stop surface extending in a plane substantially parallel to the axis, each of the second driving teeth comprises a fourth transmitting surface extending in a plane obliquely intersected with the axis, and a driving force for driving the spool to rotate is generated when the third transmitting surface and the fourth transmitting surface are caused to interact with each other.

10. The grass trimmer according to claim 1, wherein the trimming head further comprises an intermediate member synchronously rotatable with the spool and slidable relative to the spool along a direction of the axis and the first transmitting member is integrally formed with the intermediate member.

11. A trimming head, comprising:
a spool rotatable about an axis and formed with a winding portion for winding a cutting line;
a head housing formed with apertures for the cutting line to pass through and formed with an accommodating space for accommodating at least part of the spool;
an intermediate member synchronously rotatable with the spool and slidable relative to the spool along a direction of the axis; and
a touched element configured to be activated by a user and connected with the intermediate member;
wherein the head housing is formed with first driving teeth to drive the spool to rotate relative the head housing and the intermediate member is formed with first transmitting teeth for cooperating with the driving teeth;
wherein the trimming head has a sending mode in which a length of the cutting line extends without rotating the head housing and, in the sending mode, when the touched element is activated, the touched element drives the intermediate member to move towards a position where the first transmitting teeth cooperate with the driving teeth and the spool and the intermediate member are driven by the driving teeth to rotate relative to the head housing to send the cutting line to the apertures via the cooperation between the driving teeth and the transmitting teeth.

12. The trimming head according to claim 1, wherein, when the trimming head is in the sending mode, the first driving member and the first transmitting member are caused to cooperate to convert an axial movement of the first transmitting member into an axial movement and a circumferential rotation of the spool.

13. The trimming head according to claim 12, further comprising a biasing element configured to bias the first transmitting member to be reset in the direction of the axis.

14. The trimming head according to claim 13, wherein the head housing is formed with a second driving member for driving the spool to send the cutting line to the apertures during the resetting of the first transmitting member in the direction of the axis and the intermediate member is formed with a second transmitting member for cooperating with the second driving member to receive a driving force of the second driving member.

15. The trimming head according to claim 14, wherein the head housing comprises a first housing portion and a second housing portion, the first driving member is fixedly connected to or integrally formed with the first housing portion, and the second driving member is fixedly connected to or integrally formed with the second housing portion.

16. The trimming head according to claim 14, wherein the first driving teeth and the first transmitting teeth are staggered in a circumferential direction around the axis and the second driving teeth and the second transmitting teeth are staggered in a circumferential direction around the axis.

17. The trimming head according to claim 16, wherein each of the first transmitting teeth comprises a first transmitting surface extending in a plane obliquely intersected with the axis and a first stop surface extending in a plane substantially parallel to the axis, each of the first driving teeth comprises a second transmitting surface extending in a plane obliquely intersected with the axis, and a driving force for driving the spool to rotate is generated when the first transmitting surface and the second transmitting surface are caused to interact with each other.

18. The grass trimmer according to claim 16, wherein each of the second transmitting teeth comprises a third transmitting surface extending in a plane obliquely intersected with the axis and a second stop surface extending in a plane substantially parallel to the axis, each of the second driving teeth comprises a fourth transmitting surface extending in a plane obliquely intersected with the axis, and a driving force for driving the spool to rotate is generated when the third transmitting surface and the fourth transmitting surface are caused to interact with each other.

19. The trimming head according to claim 14, wherein the intermediate member comprises a first end portion and a second end portion, the first end portion is formed with the first transmitting member, and the second end portion is formed with the second transmitting member.

20. The trimming head according to claim 11, wherein the spool is sleeved on the intermediate member, the spool is formed with an inner transmitting structure, the intermediate member is formed with an outer transmitting structure, and the inner transmitting structure and the outer transmitting structure are caused to cooperate so that the spool is synchronously rotatable with the intermediate member.
